(19) United States
(12) Patent Application Publication
(10) Pub. No.: US 2010/0115826 A1
(43) Pub. Date: May 13, 2010

(54) PEST CONTROL DEVICE

(76) Inventor: Jeremy Hamish Kerr, Auckland (NZ)

Correspondence Address: OCCHIUTI ROHLICEK & TSAO, LLP, 10 FAWCETT STREET, CAMBRIDGE, MA, 02138, US

(21) Appl. No.: 12/594,255

(22) PCT Filed: Apr. 2, 2008
(86) PCT No.: PCT/NZ2008/000077

§ 371 Date: Oct. 1, 2009

(30) Foreign Application Priority Data
Apr. 2, 2007 (NZ) 554311

(51) Int. Cl. A01M 23/14; A01M 1/12; A01M 1/06

(52) U.S. Cl. 43/124; 43/139

(57) ABSTRACT

A pest control device is provided which includes a container having at least one open end and a closed end, a sealing means adapted to substantially close an open end of the container, a closing means associated with the sealing means and adapted to substantially close the open end when activated to retain a vacuum and trap a pest within the container, and an evacuation means to evacuate the container of sufficient oxygen to cause death to the trapped pest. Also provided is a novel sensor device for sensing the presence of a pest and activating the pest control device.

### TECHNICAL FIELD OF THE INVENTION

The present invention relates to a pest control device. The present invention also relates to an improved method of killing a pest.

### BACKGROUND

Throughout this specification reference is made to the term “pest”. The term should be understood as referring to unwanted vertebrate or invertebrate animals which may cause damage to the environment or native flora and fauna. Pests that the present invention may be adapted to target include, but are not limited to, rodents, birds, insects, possums, feral cats and the like.

Pest control devices broadly fall into three categories, namely mechanical traps, chemical toxicant or fumigant related poisons, and biological controls.

Numerous devices are available for controlling pests. One typical type of trap, such as that disclosed by US Patent Publication No. 2006/0156617 entitled “Snap Trap Enclosure for Trapping and Killing Rodents”, includes a spring loaded leg which crushes or impales an animal when activated. Other common devices garrotte the animal restricting the flow of blood to the animal's brain thereby causing death.

However such units typically are single action movement devices that are messy, limited in effect and often inhumane.

There are also electrical devices which use the animal to complete an electrical circuit delivering a fatal amount of electrical current. Such devices are generally viewed as inhumane and limited to a specific animal's weight and size.

A more recent device incorporates a trap which entraps the animal before releasing CO₂ gas. Such devices have the advantage of avoiding the use of toxic pesticides. However they are expensive to operate and in general are capable of activation once only before intervention is necessary, adding significant labour cost to their use. Intervention is required to change the poison used and remove the pest from the trap.

Traps such as this also require a trigger or sensing means so that the trap may be sealed and the gas released. International Publication No. WO 87/01011 entitled “Intruder Detection System”, for example, discloses the use of micro switches and infrared light sensors for this purpose.

Chemical controls are well known in the field of pest control and include 1080 and anticoagulants, phosphides, cholecalciferal, and cyanide. However, concern about the use of chemical controls centre on environmental risks associated with their use. Chemical toxicants for pest control have the advantage of multi-dose applications to a number of animals over a period of time, although they can result in chemical residues contaminating the environment, sub-lethal dosing, and secondary poisoning.

### OBJECT OF THE INVENTION

It is an object of the present invention to provide a pest control device and/or a method of killing a target pest or pests which overcomes or ameliorates at least one of the above mentioned problems and/or to at least provide the public with a useful alternative.

### SUMMARY OF THE INVENTION

According to one aspect of this invention there is provided a device which includes:
a container having at least one open end and a closed end;
a sealing means adapted to substantially close an open end of the container;
a closing means associated with the sealing means and adapted to substantially close the open end when activated to retain a vacuum and trap a pest within the container; and
an evacuation means to evacuate the container of sufficient oxygen to cause death to the trapped pest.

Preferably the evacuation means is adapted to create a vacuum within the container.

Preferably the sealing means includes a shutter.

Preferably the container includes a bag within which a pest may be trapped.

Preferably the vacuum is created within the bag.

Preferably the sealing means includes an engagement means and a heat sealing element adapted to seal an open end of the bag.

Preferably the bag includes a valve for engagement with the evacuation means.

Preferably the closing means includes a trigger mechanism adapted to determine the presence of a pest in the container and activate the closing means.

Preferably the trigger mechanism includes a sensor device.

Preferably the sensor device includes a capacitive sensor having substantially parallel spaced-apart conductors forming a capacitor therebetween separated by an air-gap through which said pest may pass, wherein the passage of a pest causes a change in the capacitance of the capacitor.

Preferably the sensor device includes a processing means to measure and monitor the capacitance of said capacitive sensor.

Preferably said measurement is achieved by way of measuring the time taken to charge and/or discharge said capacitor.

Alternatively said measurement may be achieved by measuring the frequency of a resonant circuit including said capacitor.

Preferably said processing means is adapted to provide an output signal when the capacitance exceeds a predefined threshold.

Preferably the open end has an opening of a predetermined diameter so that the device is adapted to selectively target a range of pests.

Preferably the shutter is adapted to rapidly close the opening of the open end of the container when activated.

Preferably the shutter is hingedly connected to the container.

Preferably the shutter is adapted to contact the open end in an operating configuration thereby substantially sealing the open end.

Preferably the shutter is adapted to open after a predetermined time period.

Preferably the container is adapted to expel the pest from the device on opening of the shutter.

Preferably the container is adapted to expel the pest by gravitational means.

Preferably the container may be connected to a vertical surface.

Preferably the device optionally includes reservoir containing an asphyxiant gas adapted to be dispensed into the container.

Preferably the evacuation means is adapted to draw the asphyxiant gas into the container by evacuation of the container.

Preferably the closing means may be selected from a mechanical lever, wheel, screw action, pneumatic, hydraulic or spring action unit.

Preferably the closing means may be powered by a mains supply, solar power, wind power, spring or battery power or any combination thereof.

Preferably the container has a resilient, tubular elongate body.

Preferably the closing means may be optionally activated manually, automatically or remotely.

Preferably the device includes a communications means.

Preferably the device may send status notification messages using said communication means.

Preferably the device may be controlled remotely using said communication means.

Preferably the communication means is provided by way of a GSM module, the device being adapted to communicate by sending and/or receiving SMS messages.

According to a further aspect, the invention may broadly be said to consist in a method of resetting a trap after killing a pest including the step of mounting a device according to any one of the preceding statements to a vertical surface such that the open end is directed towards the ground.

According to a further aspect, the invention may broadly be said to consist in a method of

killing a pest including the steps of:
trapping the pest in a container; and
evacuating the container of sufficient oxygen to kill the pest.

Preferably the method further includes the step of sealing the container.

Preferably the container includes a plastic bag.

Preferably evacuation of the container initiates the release of an asphyxiant gas into the container.

According to a further aspect, the invention may broadly be said to consist in a sensor device for determining the presence of a pest or pests within a confined space, the device including a capacitive sensor having substantially parallel spaced-apart conductors forming a capacitor therebetween separated by an air-gap through which said pest(s) may pass, wherein the passage of a pest causes a change in the capacitance of the capacitor.

Preferably the device includes a processing means to measure and monitor the capacitance of said capacitor.

Preferably said measurement is achieved by way of measuring the time taken to charge and/or discharge said capacitor.

Alternatively said measurement is achieved by way of measuring the frequency of a resonant circuit including said capacitor.

Preferably said processing means is adapted to provide an output signal when the capacitance exceeds a predefined threshold.

Preferably said output signal is used as a trigger.

According to a further aspect of this invention there is provided a pest control device substantially as herein described with reference to any one of the Figures of the accompanying drawings.

According to a further aspect of this invention there is provided a method of resetting a trap after killing a pest substantially as herein described with reference to any one of the Figures of the accompanying drawings.

According to a further aspect of this invention there is provided a method of killing a pest substantially as herein described with reference to any one of the Figures of the accompanying drawings.

According to a further aspect of this invention there is provided a sensor device for sensing the presence of a pest or pests within a confined space substantially as herein described with reference to any one of the Figures of the accompanying drawings.

### BRIEF DESCRIPTION OF THE DRAWINGS

The present invention will now be described by way of example and with reference to the drawings in which:

FIG. 1: is a partially transparent side view of a preferred embodiment of a device of the present invention attached to a tree in an (a) operating and (b) active configuration;

FIG. 2: is various views of the device of FIG. 1: (a) plan top view, (b) side view, (c) partially transparent front view, and (d) plan bottom view showing the device in an operating configuration.

FIG. 3: is a cross-sectional view of the device of FIG. 1 including an optional extension unit.

FIG. 4: is a perspective view of the device of FIG. 2 including an optional extension unit: (a) in an operating configuration; and (b) in an active configuration.

FIG. 5: is a series of perspective views of a further embodiment of a device according to the present invention, shown: (a) fully assembled, (b) with part of the housing removed, and (c) in an exploded perspective view.

FIG. 6: shows several views of a further preferred alternative embodiment of a device according to the present invention, shown: (a) in a front cross-sectional view, (b) a side cross-sectional view, and (c) a perspective view.

FIG. 7: is a block diagram of a sensing device according to the present invention.

### PREFERRED EMBODIMENT OF THE INVENTION

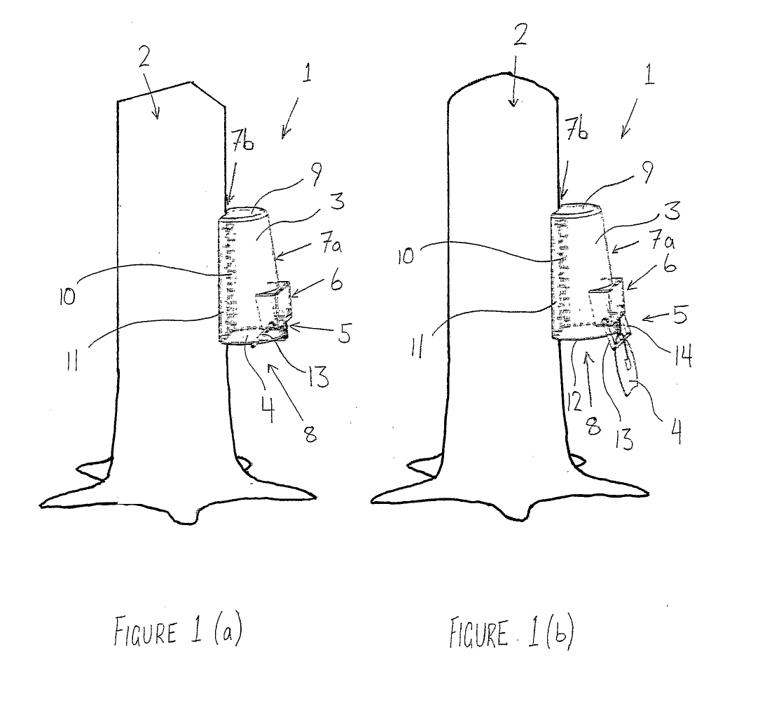

Referring to FIG. 1, a preferred embodiment of a device 1 of the present invention is shown in a plan perspective view attached to a tree in a vertical orientation. The device 1 is attached to a tree 2 in FIGS. 1a and 1b. The device 1 includes a container 3, a shutter 4 (partially obscured in FIG. 1a), a closing means 5, and an evacuation means 6.

In FIG. 1a the device 1 is shown in an operating configuration, while in FIG. 1b the device 11 is shown in an active configuration. In an active configuration the device is set to trap a pest.

The container 3 has a substantially resilient, tubular elongate body. In the preferred embodiment the body is formed from a resilient rigid plastics material or metal which is able to withstand a vacuum pressure of between −20 kPa and 95 kPa (where 100 kPa is 1 atmospheres).

The device 1 may be adapted to connect to a variety of surfaces. The container 1 includes a curved outwardly directed exterior side 7a and a substantially flattened or partially inwardly curved side 7b. The substantially flattened side 7b is adapted to improve connection of the device 1 to a tree or vertical surface for example.

The container 3 may be of any shape, but is preferably tailored to suit containment of a predetermined pest.

The container 3 includes an open end 8 and a closed end 9. The open end 8 is adapted to allow a pre-determined pest to enter the container 3. The open end 8 is directed towards the ground which allows the device 1 to be reset. The open end 8 is designed to provide an opening 12 (FIG. 1b) which is of a size that allows the predetermined pest access into the container 3 and preferably excludes large and/or non-targeted animals. The open end 8 and opening 12 are best illustrated in FIG. 1b. The size of the opening 12 of the open end 8 and the size of the container 3 generally can be modified depending on the pest to be trapped. It will also be appreciated that there may be more than one open end 8. For example, the closed end 9 could be replaced with another open end or alternatively the device 1 may include various open end entrances into the container 3.

In one preferred embodiment, the size of the container 3 is adapted to contain comfortably a brush tail possum of up to a weight of 6 kgs, approximately 50 cm long, and 25 cm in diameter, or a rodent of approximately 35 cm long and 20 cm in diameter. However, the container 3 and opening 12 may be of any size or shape.

A bait (not shown) may be mounted within the container 3 to encourage the pest into the container 3. The selection of a bait will be highly dependent on the particular pest which is to be targeted by the device 1. The bait may be mounted on a trigger mechanism adapted to activate the closing means 5 as will be described below. There may be more than one bait or lure dispensed at one time within the container to attract a range of target pests, and a ‘pre-feed’ or smaller amount of bait may be provided at or substantially adjacent the opening 12 of the device 1 to entice a pest to enter before being lured further inside by the main bait.

The device 1 may optionally include a climbing means 10 mounted within the container 3, to facilitate pest access into the container 3. The climbing means 10 is mounted on an internal surface 11 of the container 3. The climbing means 10 is optional and its incorporation is highly dependent on the particular pest to be targeted by the device 1. For example, a rat may use the climbing means 10 to improve its movement into the container 1 to reach the bait. If the target pest is a bird or an invertebrate pest for example, a climbing means 10 may be unnecessary. The climbing means 10 or a rung (obscured in FIGS. 1a and 1b) of the climbing means 10 may provide a pressure activated trigger mechanism to activate the closing means 5 so the device 13 converts to the operating configuration (of FIG. 1a). The open end 8 of the container 3 may be closed by a sealing means, which in the illustrated embodiment is in the form of the shutter 4.

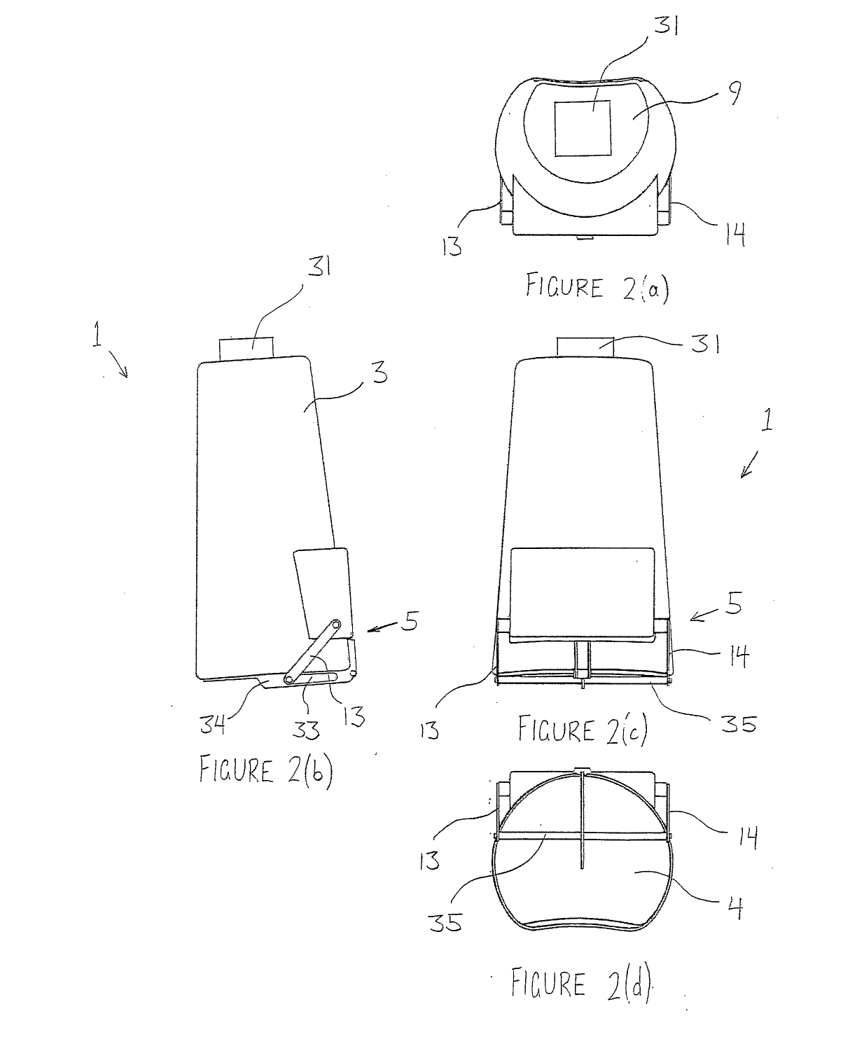

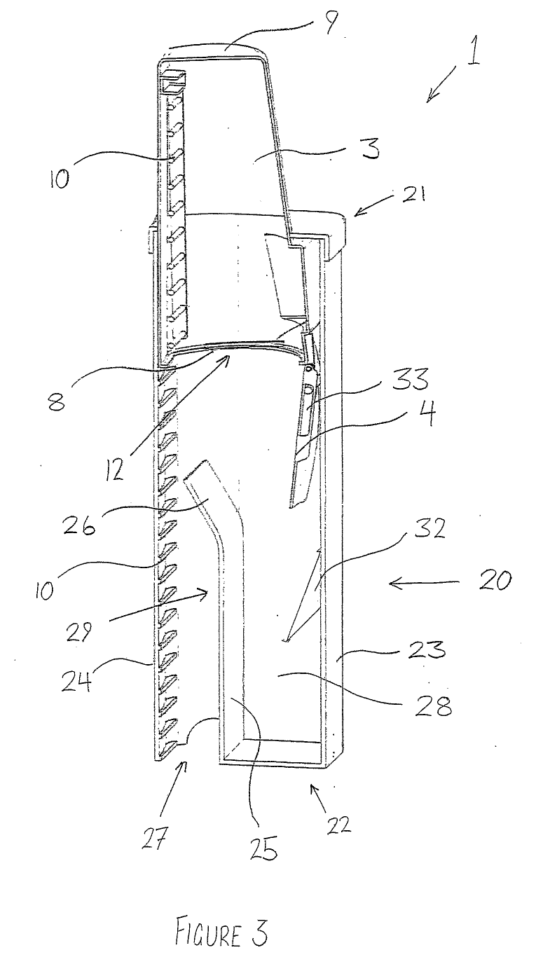

The shutter 4 is adapted to close rapidly thereby preventing a pest from departing from the container 3 once the pest has entered the container 3 and triggered the closing means 5. In a preferred embodiment, the shutter 4 is a plate which is adapted to cover the whole of the opening 12 when in the operating configuration. The outer surface of the shutter 4 has a base plate which extends outwardly from the shutter 4 and provides a means for the closing means 5 to connect. The base plate will be discussed below with reference to FIG. 2.

The shutter 4 is hingedly engaged to the container 3 and is capable of moving from active configuration to the operative configuration and back to the active configuration. Of course if there is more than one open end, a further shutter will be provided to block the additional open end(s).

As mentioned above, the container 3 includes a closing means 5 associated with the shutter 4 or shutters. The closing means 5 is adapted to close the shutter 4 rapidly across the open end 8 of the container 3 once triggered by the trigger mechanism located somewhere within the container 3. The closing means 5 may include any form of mechanical or electrical unit which can close the shutter 4. In the preferred embodiment, the closing means 5 is selected from a mechanical lever, wheel, screw action, pneumatic, hydraulic or spring action. Preferably the closing means 5 is adapted to close the shutter 4 at a speed capable of preventing the pest escaping, but reducing in speed towards the last part of operation (substantially 5 mm from fully closing) to allow for the pest trapped to withdraw its tail or other appendages into the container 3. Alternatively, the shutter 4 may close substantially to prevent the pest escaping, then pause for a predefined period of time of between 1 and 60 seconds before closing completely, if the shutter 4 cannot close completely to form a seal, it may be configured to open and re-shut should the pests tail become trapped, for example. In this way the shutter 4 can form a substantially airtight seal across the open end 8.

The trigger mechanism forming part of the closing means 5 may be located under the bait (not shown) or climbing means 10, or as part of a rung of the climbing means 10 for example. Those skilled in the art will be aware of possible trigger mechanisms which may be inserted into the container 3 which may be used to activate the shutter 4, such as a mechanical or electronic pressure sensor, or an infrared light sensor. In the preferred embodiment, however, the trigger mechanism consists of a sensor device including a capacitive proximity sensor.

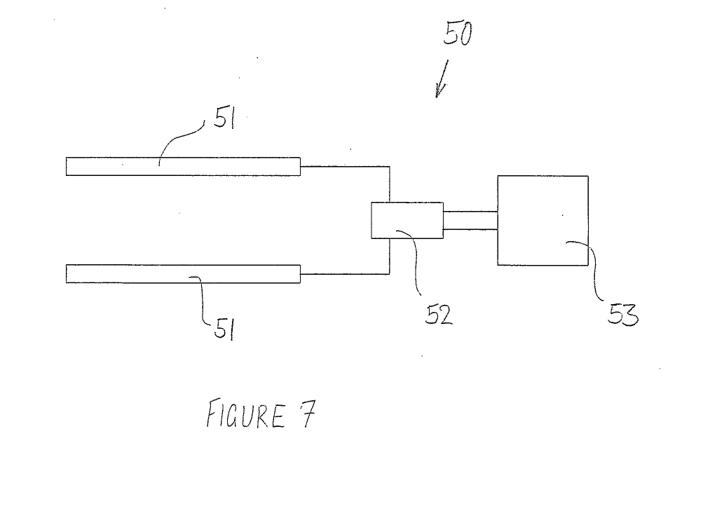

Referring to FIG. 7, a suitable sensor device 50 for determining the presence or passage of a pest consists of at least two opposed, preferably parallel, conductors 51 spaced apart within or substantially adjacent the container 3 with an air gap therebetween forming the dielectric medium. The distance between the conductors 51 is sufficient to accommodate the pest, and the pest is forced to pass between the conductors 51 to reach the bait. As the pest passes between the conductors 51, its higher relative permittivity alters the overall permittivity between the conductors, causing a change in the capacitance of the circuit.

The capacitance between the two conductors may form part of a resonant circuit. Any change in the capacitance therefore causes a corresponding change in the frequency of the resonant circuit, and the frequency may therefore be monitored to determine the passage of a pest into the trap.

Preferably, however, the change in capacitance is amplified by a signal-conditioning operational amplifier 52 which is then monitored and measured by a processing means 53, such as a microcontroller, based upon the time taken to charge and/or discharge the capacitor. That time is preferably measured at a frequency of between 1 and 20 Hz although other measurement frequencies, or irregular measurement, may be used provided that sufficient time is allowed for the capacitor to fully charge and discharge between consecutive measurements.

The processing means 53 is preferably programmed to provide an output signal when a predefined capacitance threshold is exceeded, thereby actuating or triggering the closing means 5 to close the sealing means and trap the pest within the container as herein previously described, for example. Alternatively, or additionally, the output signal may be used to control one or more status indicators 47, preferably in the form of one or more light emitting diodes.

It is envisioned that the capacitive sensor 50 may also have alternative applications in detecting the presence of pests or other animals, for example when placed in a shipping container to determine the presence of pests, or in a nest or burrow to trigger the activation of a camera, for example.

Referring again to FIGS. 1 and 2, the closing means 5 also includes two spaced apart arms 13, 14 which are slideably engaged with the base plate of the shutter 4 via an axle 35. The closing means will be further described below with reference to FIG. 2.

The device 1 also includes an evacuation means 6 adapted to provide a vacuum within the container. The evacuation means 6 is adapted to evacuate the container 3 of oxygen sufficiently to cause death to a pest by way of a brain embolism and/or asphyxiation.

In this way the pest contained within the container is starved of oxygen and dies rapidly. In the preferred embodiment the evacuation means has a vacuum or low pressure state of between −20 kPa to −95 kPa (datum as −100 kPa a full vacuum) to ensure a quick death of the trapped pest. While vacuum pressures outside of this range may be used, vacuums of a lower pressure state of between −80 to −95 kPa will induce rapid brain embolism and/or asphyxiation and cause the rapid death of the pest. The evacuation means may include an evacuation pump.

Preferably the closing means and evacuation pumping process may be powered by a mains supply, solar power, wind power, spring or battery power or any combination thereof.

Referring to FIG. 2, a possible alternative embodiment of the device 1 is illustrated. The device includes a reservoir 31. An asphyxiant gas may be released from the reservoir when the container 3 is evacuated, preferably as a gas from the reservoir 31, once a volume of oxygen is removed from the container 3. In FIG. 2a the device 1 is shown from the closed end 9 illustrating the reservoir 31 mounted on the closed end 9. The closing means 4 includes two arms 13, 14 spaced apart and extending from the closing means 5 towards and connecting with the shutter 4 (obscured in FIG. 2a).

FIGS. 2b and 2c illustrate side and front views of the device 1 in the operating configuration. The shutter 4 substantially closes the open end 8 of the container 3 forming a substantially airtight seal. The arms 13 (obscured), 14 are connected via an axle 35 (obscured) slideably engaged within the slot 33 of the base plate 34 of the shutter 4. Movement of the arms 13, 14 towards direction B causes the axle 35 to move along the slot 33 causes the shutter 4 to close and the device 1 to adopt the operating configuration.

FIG. 2d illustrates a bottom plan view of the device 1. The device 1 is shown in an operating configuration. Arms 13, 14 are connected by the axle 35. Axle 35 passes through slot 33 of the base plate 34. Movement of the axle 35 within the slot 33 causes the shutter 4 to move from the active configuration to the operating configuration.

Preferably the evacuation means 6 is a power operated diaphragm, rotary or piston pump or similar air pump device that once activated removes the required volume of air or oxygen. The evacuation means may be controlled by a timer and a pressure sensor to maintain a vacuum in the container 3 for a sufficient period to ensure asphyxiation of the pest, for example. This time depends upon a number of factors, including the rate of evacuation, size and/or type of pest, and vacuum pressure reached by the device 1.

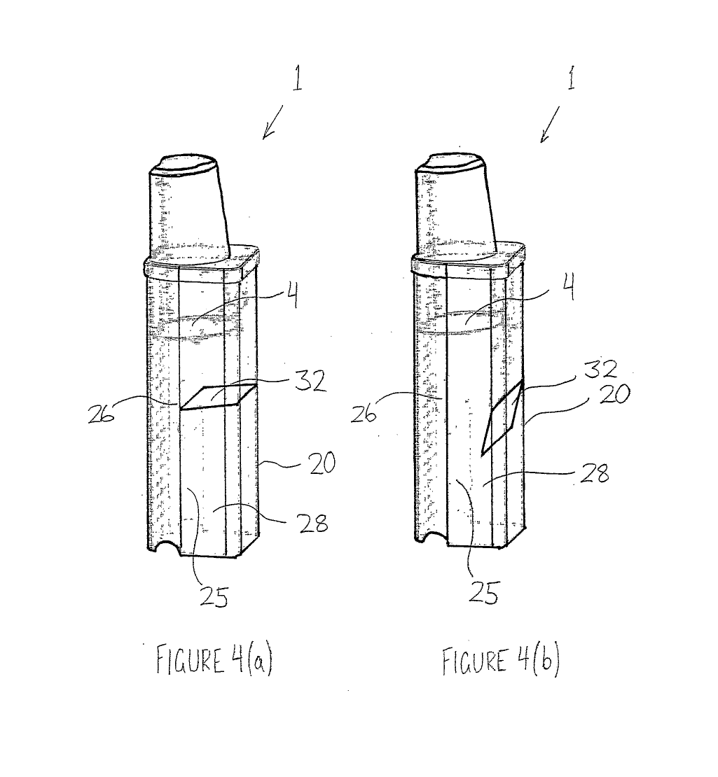

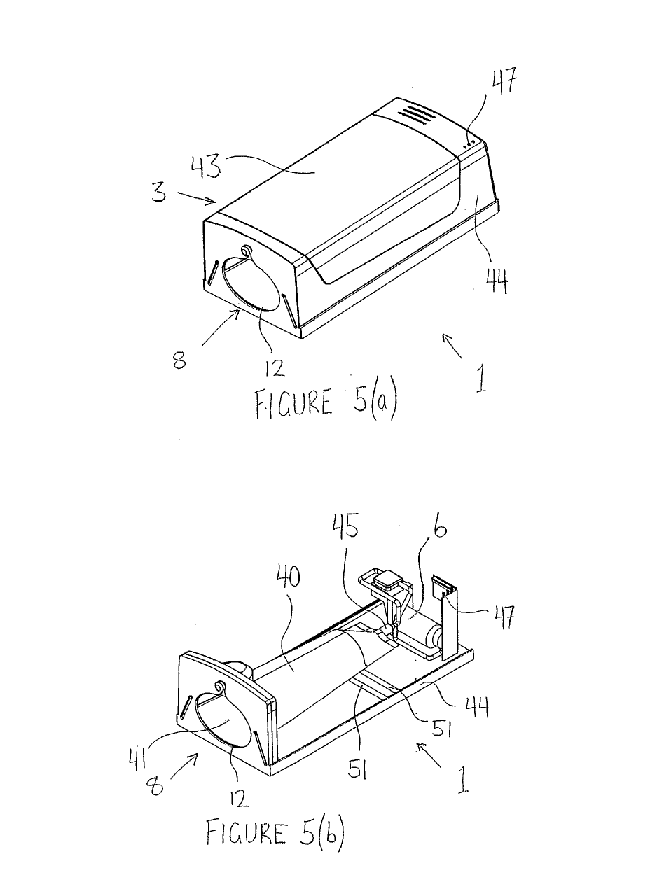

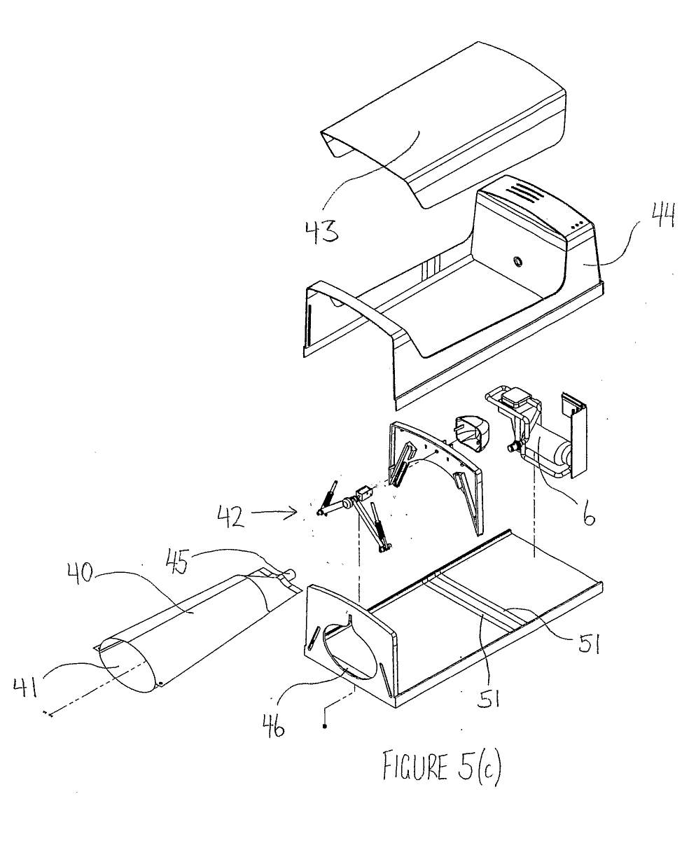

Referring to FIGS. 3 and 4, the device 1 may optionally include an extension unit 20 extending from the open end 8 of the device 1.

The extension unit 20 is adapted to extend from the open end 8. The extension unit 20 includes a body having a top end 21 and a bottom end 22. The body is also tubular and rigid and includes sides 23, 24 which substantially match the shape of the body of the device 1. The extension unit 20 may be made of a similar material to the device 1 such as a plastics material.

The bottom 22 of the body has an opening 27 to allow the target pest to enter the extension unit 20 and into the subsequent device 1. An internal partition 25 extends midway up and separates the internal space 29 of the extension unit 20. A resilient flap 26 allows a pest to push past the partition 25 and enter into the device 1. The flap 26 rebounds back to cover the opening 27 when the pest pushes past the flap 26. The flap 26 may be made of rubber or a plastics material for example. The extension unit 20 may also include a trap door 32 which the dead animal may fall through to a collection chamber 28. This is best seen in FIG. 4. Once the device 1 moves from the active configuration to the operating configuration, the container 3 is evacuated and the pest is asphyxiated. The shutter 4 then opens and the dead pest falls through trap door 32 into the collection chamber 28 in the extension unit 20.

The invention also provides a method of killing pests (or euthanizing unwanted animals).

The bait is mounted within the container 3 of the device 1. Preferably the bait may include lured impregnated polymer material a device that emits sound at various time intervals at night, a water based gel, water and other known attractants suitable for luring the target pest. The lure or bait may rest on the sensor or trigger mechanism.

The application of pressure to the trigger mechanism activates the closing means 5. The closing means 5 rapidly closes the shutter 4 substantially restricting the pest from exiting the device 1. In the preferred embodiment, the shutter 4 closes rapidly preferably within 2 seconds to close 95% of the opening 12 of the open end. The next 5% of the opening 12 may be closed slowly to allow the animal to withdraw its tail or appendage from the opening 12. This also improves the air tight seal of the shutter 4 across the open end 8.

The container 3 is then evacuated of air. This starves the animal of oxygen causing death. An asphyxiant gas may be introduced as a volume of air is removed also causing the death of the pest. The asphyxiant gas may be released from the reservoir 31.

The shutter 4 is then opened and the dead pest falls from the device 1 if the device is located vertically. If an extension unit 20 is connected to the device 1, the animal falls into the collection chamber 28. The chamber 28 may be kept secure by a door 32 that is opened only by the weight of the dead pest. This is to prevent any attending pest from entering the chamber 28 alive. This has the advantage of containing dead animals and avoiding interference with the next attending animal. In this way the present invention provides a method of automatically resetting the device after use. When the shutter 4 opens, the dead pest drops from the device towards the ground in FIG. 1, and into the collection chamber 28 in FIGS. 3 and 4, through gravitational means when the device 1 is affixed to a vertical surface.

The device 1 is automatically reset for the next attending pest.

It may be preferable that the device does not reset and the specific target pest is contained within the container 3 for inspection. Monitoring or harvesting purposes

In an alternative, or addition to the extension unit 20, the device 1 may be provided with a collection bag directly below it in which to catch any pests trapped by the device. The collection bag is preferably a sanitised plastic bag, but may consist of any other material not necessarily sanitised.

According to a preferred alternative embodiment; the container 3 of the device 1 may include a sub-container such as a bag within which bait may be placed. The bag is preferably plastic, or any other material suitable for containing a vacuum. Ideally, the bag is sealed and the vacuum is formed within the bag, however the bag may alternatively be provided inside the container 3 merely for the purpose of convenience in disposing of the pest. In this case the container 3 should be able to withstand and contain a vacuum, whereas the bag may not.

Referring to FIGS. 5(a)-(d), the container 3 may consist of, or include, a substantially airtight vacuum-proof bag 40. In the preferred embodiment as shown, the container 3 comprises a housing 44 and the bag 40 placed therein. The bag 40 has an open end 41 adapted for association with the opening 12 of the housing 44. To affect the evacuation of oxygen and maintain the vacuum within the bag once removed from the device 1, the bag 40 may include a one-way valve 45 between the bag 40 and the evacuation means 6 in the form of a vacuum pump.

The device 1 further includes a sealing means to either temporarily or permanently seal the open end 41 of the bag 40 upon entry of the pest into the device 1. In this preferred embodiment, the sealing means is in the form a heat sealing element 46 and an engagement means 42 for pressing the bag 40 against the heat sealing element 46 at or substantially adjacent the open end 41 to form a heat seal.

A pest may enter the device 1 via the opening 12 into the open end 41 of the bag 40, activating the device whereupon the sealing means 42 seals the open end 41 of the bag 40 and the evacuation means 6 is activated to create a vacuum inside the bag 40, thereby asphyxiating the pest. The plastic bag containing the vacuum-packed pest may then be disposed of. This embodiment therefore has the advantage of providing a hygienic means of disposal, and/or preservation of the pest for inspection, evidence, or use of the pest for other purposes such as the use as a food source. The bag 40 may also include repellents to prevent animals such as cats and/or dogs chewing on the bag in an attempt to eat or otherwise access the dead pest. The bag may also be sanitised.

To assist in the replacement of the bag 40 and resetting of the trap, the container 3 may include a removable lid 43. This lid may be transparent so that it can be seen whether or not the trap needs to be reset. Alternatively, or additionally, it is envisioned that the device 1 may be provided with a plurality of bags 40 with which the device 1 may be automatically reset as herein described above.

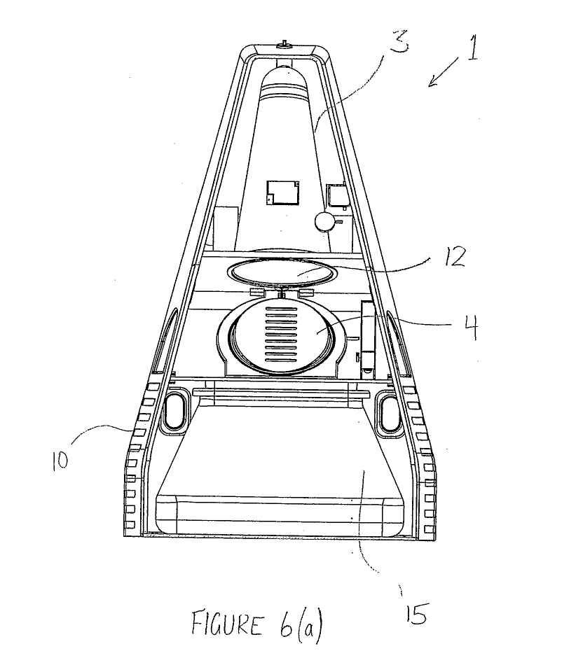

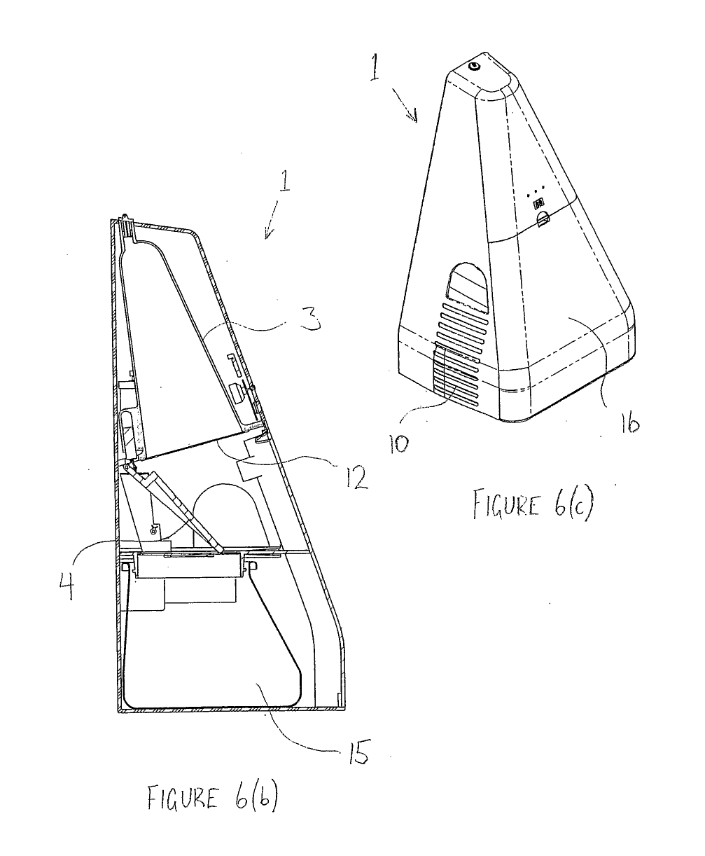

Referring now to FIGS. 6(a)-(c), a preferred alternative embodiment to the device is shown. This embodiment is adapted for use when placed on the floor, providing an external climbing means 10 and an internal chamber 28 for the collection of asphyxiated pests. The chamber 28 is preferably lined by a collection bag 15 as shown. A small bait or pre-feed may be provided inside the device 1 below the container 3 where the main bait is held (not shown).

The collection chamber 28 may be integrated within the device 1 which is preferably provided with an access door 16 to facilitate emptying of the chamber 28 by removal of the collection container 15 as shown, or the chamber 28 may be provided by way of a removable extension unit 20 which may itself be used to dispose of collected pests. The device 1 may be adapted for tree, wall, or floor mounted use by way of replacement with the appropriate extension unit 20.

According to the preferred embodiment, the invention may also be provided with a communication means operative to send status notification messages indicating changes in the status of the device, e.g. the trapping of a pest, by wired and/or wireless communication. Preferably the communication means may be in the form of a GSM (Global System for Mobile communications) module or mobile phone adapted to communicate with one or more predefined mobile phone numbers by SMS (Short Message Service) messages. The device 1 may therefore send a message to a dedicated distribution computer and/or one or more personal mobile phones indicating that the device must be reset or that the chamber 28 of the extension unit 20 is full, for example.

Communications may be controlled by the same microcontroller controlling the capacitive sensor 50, if present, or a separate microcontroller. After sending a message, the microcontroller may automatically reset the device or shut it down to conserve power, or the device may be controlled remotely and may therefore only reset itself in response to a received message to do so. Although the communications module has been described with respect to GSM/SMS communications, it will be apparent to those skilled in the art that any alternative wired and/or wireless communications medium and communications standard may alternatively be used.

The invention therefore provides an improved method of killing pests by a humane and secure process. by (1) trapping a pest in a container; and then (2) evacuating the container of sufficient oxygen to cause death to the pest. In a preferred embodiment the pest is hygienically sealed within a vacuum-packed plastic bag. In an alternative embodiment of the invention, the evacuation process may initiate release of an asphyxiating gas into the container 3 to increase the speed of the pest's death. The asphyxiating gas may be drawn from the reservoir 31 by evacuation of the container 3.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope or spirit of the invention.

1-47. (canceled)

48. A pest control device comprising:
a container having at least one open end and a closed end;
a shutter adapted to substantially close an open end of the container;
an actuator associated with the shutter and adapted to substantially close the open end when activated to retain a vacuum and trap a pest within the container; and
an evacuation pump for creating a substantial vacuum within the container, the vacuum being sufficient to cause rapid death to the pest by way of a brain embolism.

49. A pest control device as claimed in claim 48, wherein the vacuum has a vacuum pressure between 80 kPa and 95 kPa below atmospheric pressure.

50. A pest control device as claimed in claim 48, wherein the container comprises a bag within which a pest may be trapped.

51. A pest control device as claimed in claim 50, wherein the vacuum is created within the bag.

52. A pest control device as claimed in claim 50, wherein the shutter comprises a heat sealing element adapted to seal an open end of the bag.

53. A pest control device as claimed in claim 50, wherein the bag comprises a valve for engagement with the evacuation pump.

54. A pest control device as claimed in claim 48, wherein the actuator comprises a trigger mechanism adapted to determine the presence of a pest in the container and to activate the actuator.

55. A pest control device as claimed claim 54, wherein the trigger mechanism comprises a sensor device.

56. A pest control device as claimed in claim 55, wherein the sensor device comprises a capacitive sensor comprising substantially parallel spaced-apart conductors forming a capacitor therebetween separated by an air-gap through which said pest may pass, wherein the passage of a pest causes a change in the capacitance of the capacitor.

57. A pest control device as claimed in claim 48, wherein the container is adapted to expel the pest.

58. A pest control device as claimed in claim 48, wherein the device further comprises a communications module.

59. A pest control device as claimed in claim 58, wherein the device may send status notification messages using said communication module.

60. A pest control device as claimed in claim 58, wherein the device may be controlled remotely using said communication module.

61. A method of killing a pest, said method comprising:
trapping the pest in a container; and
creating a substantial vacuum in the container, the vacuum being sufficient to cause a brain embolism and rapid death of the pest.

62. A method killing a pest as claimed in claim 61, wherein the vacuum pressure is between 80 kPa and 95 kPa below atmospheric pressure.

63. A method of killing a pest as claimed in claim 61, wherein the container comprises a plastic bag.

64. An apparatus for pest control, said apparatus comprising:
a container having at least one open end and a closed end;
a sealing means adapted to substantially close an open end of the container;
a closing means associated with the sealing means and adapted to substantially close the open end when activated to retain a vacuum and trap a pest within the container; and
means for creating a substantial vacuum within the container, the vacuum being sufficient to cause a rapid death to the pest by way of a brain embolism.
